(19) United States
(12) Patent Application Publication
(10) Pub. No.: US 2025/0183362 A1
(43) Pub. Date: Jun. 5, 2025

(54) CARBON BASED SURFACE TREATMENT ON SUBSTRATES TO IMPROVE WETTABILITY

(71) Applicant: Battelle Memorial Institute, Richland, WA (US)

(72) Inventors: Guosheng Li, Richland, WA (US); Mark Weller, Richland, WA (US); Henry Hyungkyu Han, Richland, WA (US); Evgueni Polikarpov, Richland, WA (US); Kee Sung Han, Richland, WA (US); David M. Reed, Richland, WA (US); Vincent L. Sprenkle, Richland, WA (US)

(21) Appl. No.: 18/910,970

(22) Filed: Oct. 9, 2024

Related U.S. Application Data
(60) Provisional application No. 63/543,418, filed on Oct. 10, 2023.

(51) Int. Cl. H01M 10/0562; H01M 10/39; H01M 50/403; H01M 50/434; H01M 50/449; H01M 50/46

(52) U.S. Cl. CPC H01M 10/0562; H01M 10/399; H01M 50/403; H01M 50/434; H01M 50/449; H01M 50/46; H01M 2300/0071

(57) ABSTRACT

An energy storage system comprising a molten alkali metal in contact with a layer disposed on a surface of a substrate, wherein the surface layer comprises a composite comprising carbon, and the surface layer is metal-free and metal oxide-free.

### CROSS REFERENCE TO RELATED APPLICATION

This application claims the benefit of U.S. Provisional Appl. No. 63/543,418, filed Oct. 10, 2023, which is incorporated herein by reference.

### ACKNOWLEDGMENT OF GOVERNMENT SUPPORT

This invention was made with government support under Contract DE-AC0576RL01830 awarded by the U.S. Department of Energy. The government has certain rights in the invention.

### BACKGROUND

Sodium-based batteries, especially molten-Na batteries such as Na—S or Na—NiCl₂ and related batteries have received a great deal of attention with the goal of providing an alternative grid-scale energy storage solution, with some advantages over Li-ion in terms of cost and discharge duration. These batteries rely on a solid-electrolyte separator such as sodium Beta Alumina Solid-Electrolyte (Na-β″-Al₂O₃, ‘BASE’) to prevent intermixing of the anode and cathode materials, while facilitating conduction of Na-ions between the anode and cathode during operation. An operable molten Na battery has good Na-wettability on the anode side of this solid-electrolyte separator, such that Na uniformly conducts. If this contact does not exist between Na and the ceramic surface, high cell resistance results. This resistance prevents high power applications unless high operating temperatures are used such that Na finally wets the ceramic surface.

Since higher operating temperatures result in more heat loss (energy inefficiency), and require heat resistant materials of construction, there has been a major drive to operate molten-Na batteries at lower temperatures. Many recent examples give a sense of the level of interest in this field. In order to enable this low temperature operation for practical batteries, some method of increasing the wetting of molten Na on the anode is mandatory.

Elevated temperature molten Na batteries are seeing a resurgence of interest for low-cost electrochemical energy storage for the grid. Of the many recent innovations in this battery concept, new methods focused on intermediate temperature operation (e.g. 110-190° C.) have gained prominence as a way to enable comparable performance with less thermal energy loss and lower-cost materials of construction. However, the poor wettability of molten Na on suitable solid-electrolyte separators such as BASE requires continued innovation in interface engineering to promote full utilization of the solid-electrolyte surface area and minimize cell resistance. There have been many successful approaches to improve Na-wettability to-date including heat treatment in an inert atmosphere to remove adsorbed surface species, deposition of alloying metals such as Pb, Sn, or Bi, and use of carbon-based interfacial layers. However, these approaches either lack the ability to provide good wetting at very low temperatures near the melting point of Na or rely on non-scalable processes and/or toxic/expensive metals.

### SUMMARY

Disclosed herein is a new carbon-based sodiophilic treatment that utilizes inexpensive components to form a meso/nanoporous sodiophilic layer, is easily applied at scale via spray-coating, provides excellent wetting as low as 110° C., and, in certain embodiments, is completely metal-free.

In one aspect, disclosed herein is an example of a carbon-based surface treatment and method of application that, when applied and heat-treated properly, confers excellent sodium wetting properties to a substrate. Examples of potential substrates include metals, glass, or ceramics, with a focus on sodium-ion conducting ceramics such as the sodium Beta Alumina Solid-Electrolyte (Na-β″-Al₂O₃, ‘BASE’) that is commonly used for various types of sodium batteries. Other examples could include other sodium ion conductors such as NaSICON (‘Na Super Ionic CONductor’).

Further disclosed herein is an energy storage system comprising a molten sodium-containing salt in contact with a layer disposed on a surface of a β″-alumina solid electrolyte, wherein the surface layer comprises a composite comprising carbon. In certain embodiments, the surface layer is metal-free. In certain embodiments, the surface layer is metal oxide-free.

Also disclosed herein is a method comprising applying an aqueous composition to a surface of a β″-alumina solid electrolyte, wherein the composition comprises a carbon-containing material; and thermal treating the composition-applied β″-alumina solid electrolyte in an air or inert atmosphere. In certain embodiments, the composition also includes at least one surfactant for dispersing the carbon-containing material.

Further disclosed herein is a method for assembling an energy storage system, comprising applying an aqueous composition to a surface of a β″-alumina solid electrolyte comprising a carbon-containing material; thermal treating the composition-applied β″-alumina solid electrolyte in an air atmosphere resulting in a surface-modified β″-alumina solid electrolyte; and contacting the surface-modified β″-alumina solid electrolyte with a molten sodium-containing salt.

Additionally disclosed herein is a method comprising operating a Na-metal halide battery at a temperature of less than, or equal to, 200° C., wherein the Na-metal halide battery comprises a molten sodium-containing anode salt in contact with a surface layer disposed on a β″-alumina solid electrolyte, wherein the surface layer comprises carbon. In certain embodiments, the surface layer is metal-free. In certain embodiments, the surface layer is metal oxide-free.

The foregoing will become more apparent from the following detailed description, which proceeds with reference to the accompanying figures.

### BRIEF DESCRIPTION OF THE DRAWINGS

FIG. 1 is a table summarizing presently disclosed slurry compositions and processing conditions that result in successful Na-wetting for slurries comprising 90% H₂O and 10% EtOH as co-solvent, and various additives. Carbon black: 0.33 g, Hydroxypropyl Methylcellulose: 0.05 g, Tergitol: 0.1 g, Na₆(PO₃)₆:0.11 g, Water 18 ml+Ethanol 2 ml. Carbon black: 0.33 g, Tergitol: 0.1 g, PVP: 0.05 g, Water 18 ml+Ethanol 2 ml. Wettability treatments were applied to borosilicate glass substrates and B″-alumina solid state electrolytes (BASE).

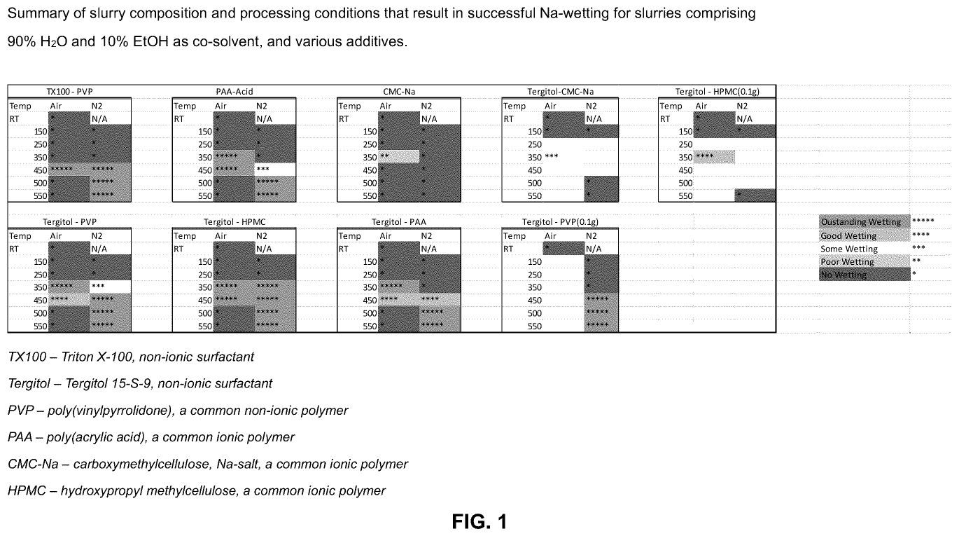

FIG. 2 is a graph showing electrochemical impedance spectra of symmetric cells with BASE separators using metal-free wetting layer treatment and lead acetate carbon-paste treatment, with the metal-free wetting layer treatment showing lower overall impedance.

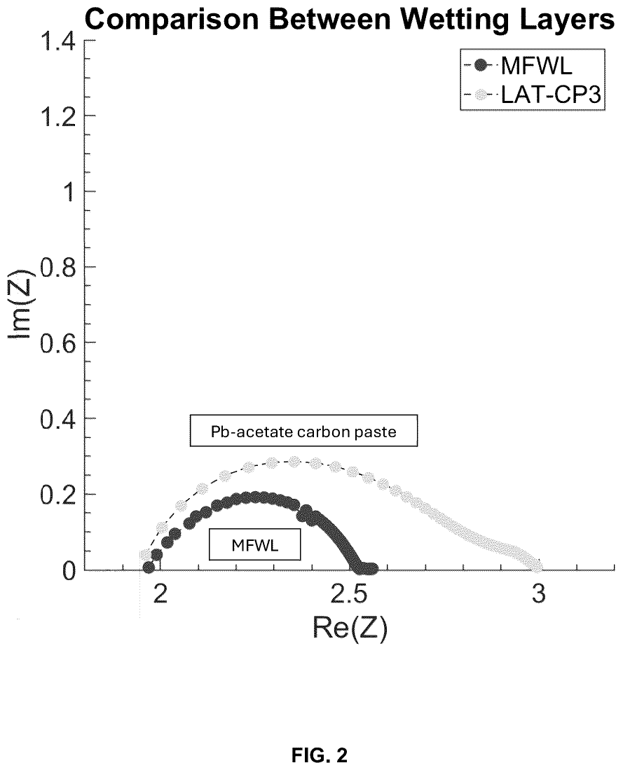

FIG. 3—(left) photographs of MFWL on glass slide before and after Na-wetting, (middle) underside of MFWL showing mirror-like surface, indicating intimate and uniform contact between glass and Na, (right) MFWL on BASE ceramic electrolyte, showing the same wetting behavior as on glass slide.

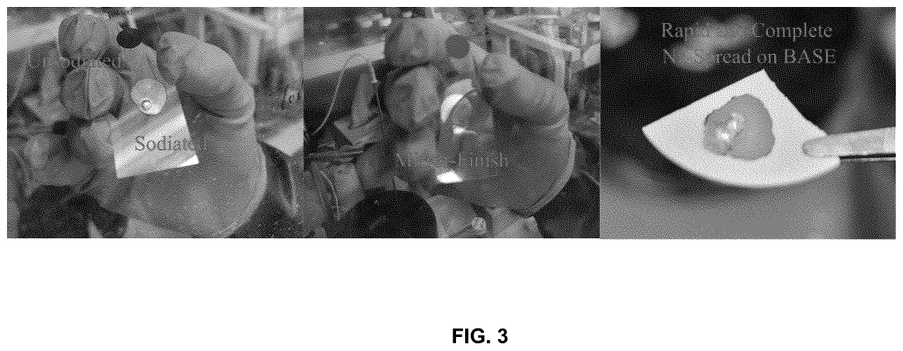

FIG. 4—a) representative low magnification (2500×) SEM image of MFWL on BASE and higher magnification HIM images of MFWL on Mo-foil with b) 10 μm and c) 2 μm field of view, showing micro and meso-structure of MFWL showing arrangement of carbon black primary particles after heat treatment, and d) pore size distribution determined from BET/BJH measurement showing homogeneous pore size for carbon paste based wetting layer and a wider range of pore sizes for the metal-free wetting layer.

FIG. 5—pre-sodiated photos of a) BASE piece with metal-free wetting-layer (MFWL), b) anode side of a symmetric cell with MFWL, and c) backscatter SEM image and d) SEM-EDS map (20,000× magnification) of pre-sodiated MFWL showing clean interface and intimate contact between MFWL and underlying BASE substrate and Na-metal ‘islands’, post-sodiated photos of e) BASE piece with MFWL, f) anode side of a cell with MFWL (after disassembly), g) backscatter SEM image and h) EDS-Map (20,000× magnification) of post-sodiated MFWL showing intimate contact between Na-metal and BASE (note that columnar features are due to the different milling rates from the ion-beam with Na/BASE interface).

FIG. 6—a) Nyquist plots of impedance spectra from MFWL symmetric cell between 110-160° C. with simple equivalent circuit model used for fitting (inset) and datapoints colored by frequency, note that the Z″ axis scale is in 1 Ω increments (major tick marks) as the impedance spectra are offset for clarity, b) distribution of relaxation times (logarithmic scale on the abscissa) of impedance data in (a) showing effects of temperature on resistance and characteristic relaxation time of different processes occurring in (a), c) tabulated circuit fit values for impedance spectra in (a).

FIG. 7—a) plot of voltage response of symmetric cycling of Na—Na cell at various current densities and temperatures between 110-160° C., b) zoom of current-staircase experiment showing cycling current densities ranging from 1-15 mA cm² and voltage response between 110-160° C. respectively, c) specific resistance calculated from the median cycle voltage of cell undergoing long-term cycling at 120° C. showing quite stable performance.

FIG. 8—analysis of symmetric Na—Na solid-state cell between room temperature and 90° C. showing a) impedance spectra, b) DRT analysis of spectra in (a), and c) current staircase experiment to assess critical current density (CCD) at 30° C., showing CCD of ˜0.47 mA cm⁻² for this cell.

FIG. 9 is a table showing examples of wetting treatment compositions. The A12 composition was used as a baseline composition for subsequent experiments and various additives. The A12 composition with sodium hexametaphosphate (SHMP) demonstrated improved properties.

FIG. 10 are scanning electron microscope (SEM) images of surface morphology of molybdenum shim substrates treated with the A12 composition having various salt additives.

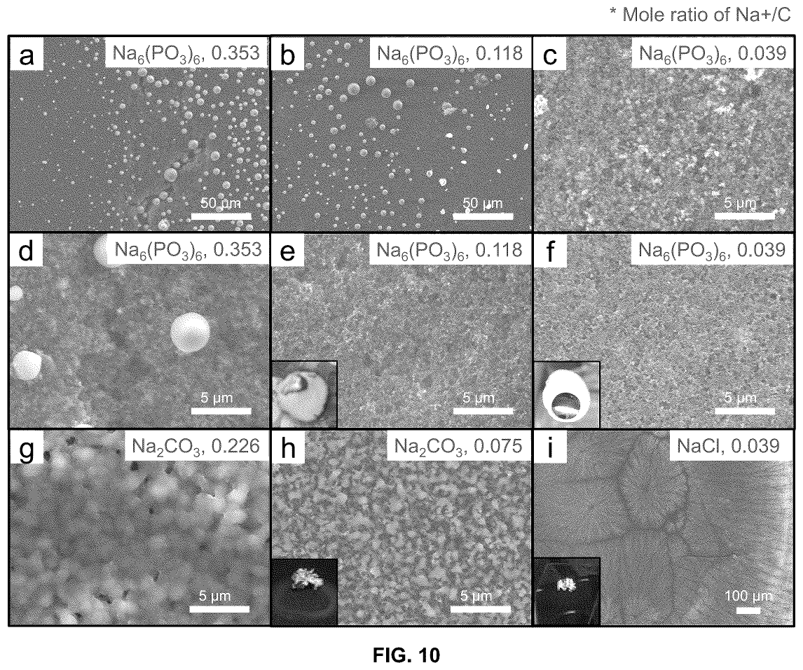

FIG. 11 are images showing film morphology and adhesion of the A12 composition having various salt additives on treated molybdenum shim substrates. Addition of Na₆(PO₃)₆ (sodium hexametaphosphate (SHMP)) or NaCl (1:3 salt to carbon ratio by mass) showed improved properties.

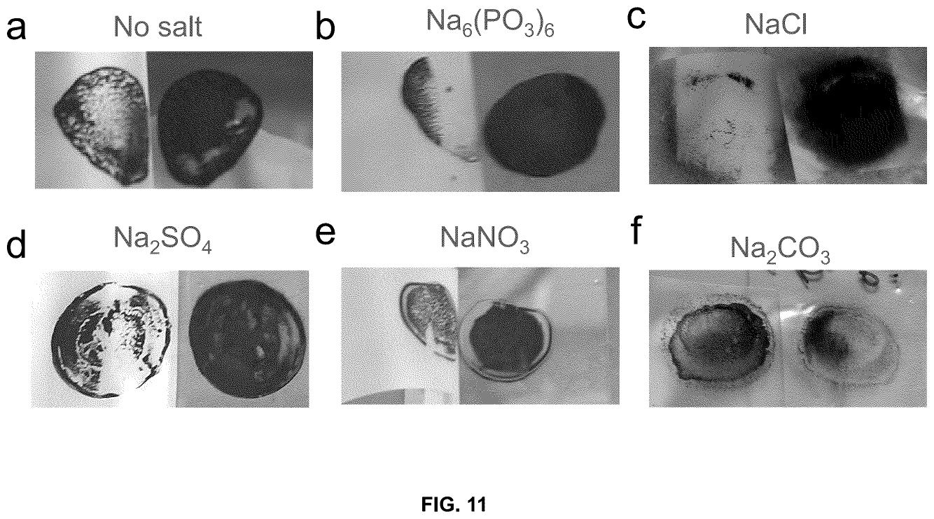

FIG. 12 are images showing treated molybdenum shim substrates surface wettability with different Na salts.

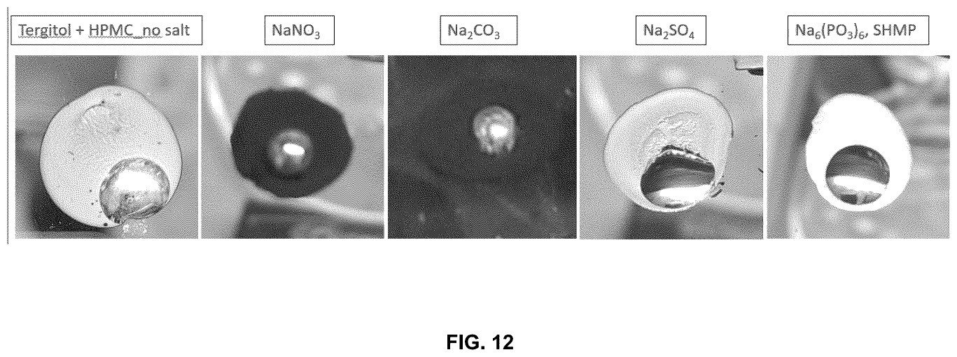

FIG. 13 is a table showing the molybdenum shim substrate surface wetting performance of compositions at different salt concentrations.

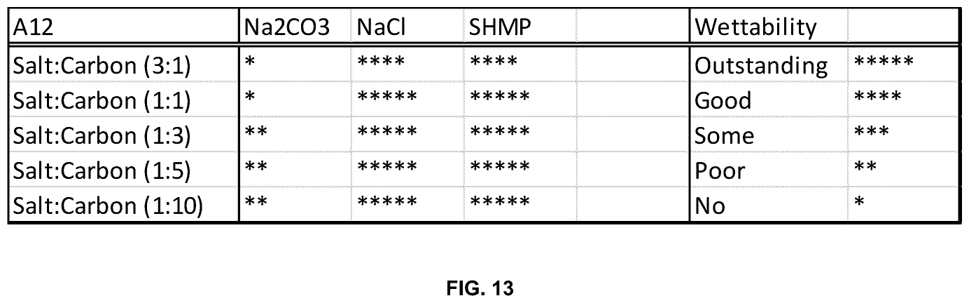

FIG. 14 is a table showing the molybdenum shim substrate surface wetting performance of different compositions. Na wettability: A12+SHMP>A12+Na₂SO₄, A12+Na₂B₄O₅(OH)₄>A12>A12+NaCl>A12+Na₂SO₄, A12+NaNO₃. Test condition: A12+salts 120° C.

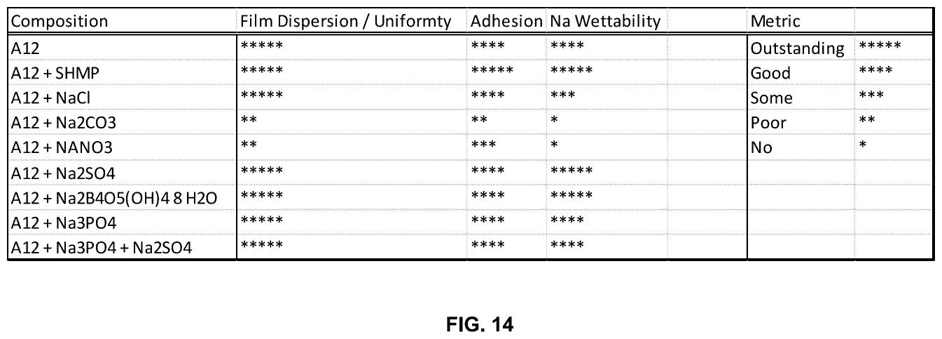

FIG. 15 are images comparing different carbon black air annealing results. The samples were annealed at 350° C. in an ambient air atmosphere on glass slides.

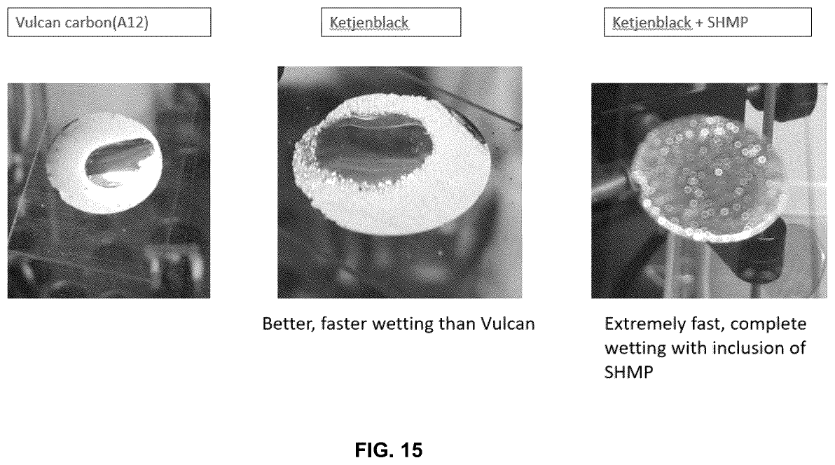

FIG. 16 are SEM images of wetting layer microstructures with Vulcan™ carbon black (top and bottom left images) compared to those with Ketjenblack™ carbon black (top and bottom right images). The wetting treatment composition is the A12 composition. The compositions with Vulcan™ carbon black show larger pores with well-dispersed primary Vulcan particles. The compositions with Ketjenblack show larger agglomerates composed of very small, porous aggregates. The Ketjenblack composition has a fluffy surface texture due to individual small Ketjenblack particles aggregating into larger secondary particles.

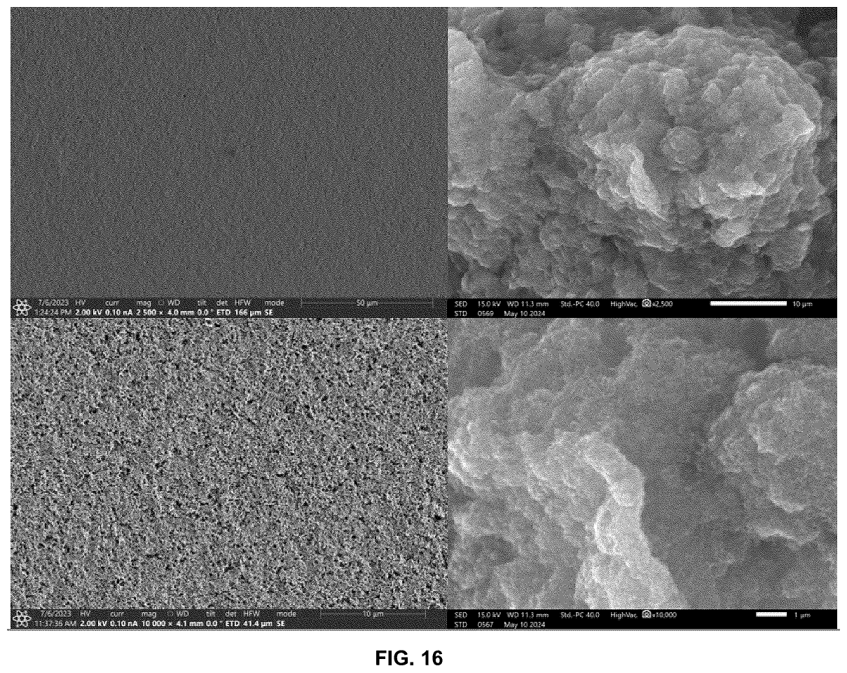

FIG. 17 is a graph showing electrochemical impedance spectra of duplicate solid-Na symmetric cells that include the A12 wetting treatment composition on both sides of a Na-β″-Al₂O₃ solid-electrolyte (˜2 cm² area) and heat treated at 550° C. in flowing N₂. After melting Na-metal on both sides of the solid-electrolyte, the cells were assembled into a coin cells with a thin (0.5 mm) steel spacer and a wave spring, and crimped. The cells were characterized by electrochemical impedance spectroscopy at 30° C.

FIG. 18 are graphs showing electrochemical cycling results of duplicate solid-Na symmetric cells (as in previous paragraph) that include the A12 wetting treatment composition. The cells were cycled for three cycles each at increasing current densities up to 2 mA cm⁻². Where Cell A in this test was able to cycle up to 2 mA cm⁻², Cell B failed before reaching that current density. The difference in current density that could be sustained between Cell A and Cell B are attributed to differences in coating uniformity.

FIG. 19 is a graph showing electrochemical results of the aforementioned Cell A that includes the A12 wetting treatment composition at higher current densities. In this case, at a current density of ˜4.6 mA cm⁻², the cell failed due to internal short (i.e., Na-dendrite intrusion into solid-electrolyte).

FIG. 20 is a graph showing electrochemical impedance spectra of a solid-Na symmetric cell that includes the A12 wetting treatment composition that also contains SHMP. This cell was prepared using the same procedure as Cell A/B discussed previously. Electrochemical impedance spectroscopy was performed between 20-60° C.

FIG. 21 is a graph showing electrochemical cycling results of the aforementioned solid-Na symmetric cell that includes the A12 wetting treatment composition with SHMP additive. This cell was tested at 25° C. using a similar increasing current density up to 3 mA cm⁻², showing no failure due to short circuit (i.e., Na-dendrite intrusion into solid-electrolyte).

FIG. 22 is a graph showing electrochemical cycling results of the aforementioned cell that includes the A12 wetting treatment composition with SHMP additive. In this case, at a current density of ˜5.8 mA cm⁻², the cell failed due to an internal short (i.e., Na-dendrite intrusion into solid-electrolyte).

FIG. 23 is a series of images showing (a,b) early implementations of the MFWL using carbon black, drop-cast from a methanol-based slurry onto glass slides, showing excellent wetting, spreading, and adhesion to the substrate. Images c,d show the spontaneous and complete infiltration of molten Na when applied to carbon black without any additives—in this case the carbon black powder was gently pressed into a disk onto a Molybdenum substrate. The left substrate in (c) was heat treated at 550° C. in flowing N₂ much like a standard heat treatment protocol, while the right substrate in (c) (also shown in (d)) is completely untreated carbon black. This shows that, so long as the inherent sodiophilic nature of carbon black is not altered, and that so long as high porosity is maintained, carbon black can be applied via a variety of methods to enable a sodiophilic coating layer.

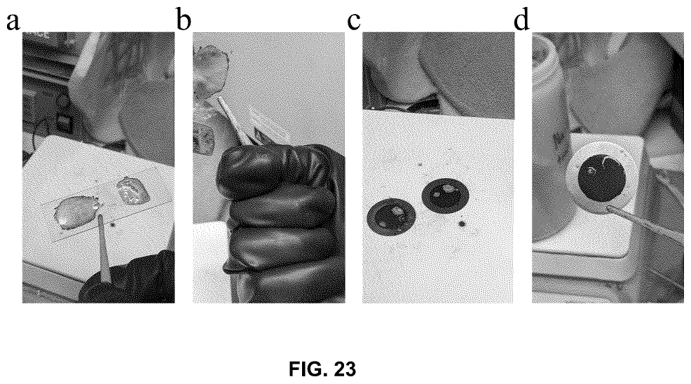

### DETAILED DESCRIPTION

The purpose of the abstract and following description is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

Various advantages and novel features of the present compositions and methods are described herein and will become further readily apparent to those skilled in this art from the following detailed description. The following descriptions shows and describes various embodiments and aspects of the compositions and methods. The drawings and description of the embodiments set forth hereafter are to be regarded as illustrative in nature.

Oxide ceramic ion conductors such as alumina-phase solid electrolytes are good solid electrolytes for load-leveling batteries as they provide a strong ionic conductivity given the high concentration of sodium ions that pass through the electrolyte. Solid electrolytes comprised of β″-alumina phase material (known as β″-alumina phase solid electrolytes (BASE)) are preferred because sodium ions are the only conducting ions in the BASE material.

Among various Na-based rechargeable batteries, a ZEBRA battery is usually operated at relatively high temperatures (260˜320° C.), which is well above the melting point of the liquid electrolyte (NaAlCl₄, Tₘ at 157° C.), to achieve adequate battery performance by reducing the ohmic resistance of the β″-alumina solid-state electrolyte (BASE) and by improving the ionic conductivity of the secondary electrolyte.

However, particle growth and side reactions occurring in the cathode are also enhanced at high operating temperatures and can result in degradation of performance and/or lifetime. Therefore, an improved ZEBRA energy storage device that operates at lower temperatures is needed. Recently, intermediate-temperature (IT) Na-metal halide (Na-MH) batteries with operating temperature near 200° C. have demonstrated several advantages over conventional high-temperature ZEBRA batteries, including superior battery safety, lower operating temperatures, manufacturing cost, potentially longer cycle life, and easier assembly.

One of main challenges for developing practical lower temperature Na-MH batteries is the unique temperature dependence of the Na wettability on the BASE surface. Due to intrinsic features of molten sodium, the relatively high surface tension of molten sodium (˜200 mN/m) compared to water (˜73 mN/m) tends to work against good Na wetting and lead to poor Na wettability, which poses a huge technical barrier for the IT Na-MH batteries to be operated at even lower temperatures.

In the past, various methods have been employed to improve the Na wetting on the BASE surface. For tubular-type high temperature Na—S and ZEBRA batteries, a thin coating of carbon or carbon felt followed by a thermal treatment were applied on the BASE surface to improve the Na anode performance. Developing preferable sodium wetting at lower temperatures (<200° C.) is crucial for demonstrating lower operating temperature Na-MH batteries. One approach for improving Na wetting on BASE is sputtering a thin layer of metal coatings on vacuum heat-treated BASEs to remove possible impurities on the BASE surface such as moisture and surface hydroxyl groups. Metal coatings by sputtering (e.g., Sn, Bi, and In) or porous nanostructures (e.g., Ni nanowires, Pt mesh, and Pb particles) were applied to the surface of BASE to increase the adhesive energy between metal (Na)-metal coating contacts and to prevent moisture from being absorbed onto BASE. Another approach is using Na alloys (Na—Cs, Na—Bi), which improve the wettability by larger work of adhesion of Na alloys compared to that of pure Na.

However, most methods reported in the literature either use surface treatment methods (sputtering, vacuum treatment, etc.) that are far less practical for large scale production or are associated with high-cost materials. Carbon materials were used in the past; however, its application was limited for the high temperature (>280° C.) batteries because a good Na wetting on carbon treated BASE was only available at higher temperatures.

Another previous method for improving Na wetting on BASE involves a surface treatment process through thermal decomposition of Pb(OAc)₂·3H₂O (LAT), which disseminated micron and submicron Pb particles on the ceramic surface (Chang et al., Decorating β″-alumina solid-state electrolytes with micron Pb spherical particles for improving Na wettability at lower temperatures, J. Mater. Chem. A 2018, 6, 19703-19711). During the evaluation of surface interactions, small contact angles from the sessile drop experiments trended qualitatively with good surface wetting, even though the increasing complexity of the surface modification resulted in a sunny-side-up drop behavior that required modeling beyond Young-Dupré relation. Furthermore, as we increased the treatment temperature of LAT, the surface metallic content of the Pb particles increased, which led to better wetting at temperatures as low as 120° C. As improved wetting was visually represented by a fast spread of molten metallic sodium, the key mechanism was attributed to the wicking or infiltration of metal into the treatment layer, promoted by formation of Na—Pb alloy on the particle surface in this case.

Furthermore, Na-wettability has implications for solid-state Na-batteries as well. Applying an interlayer with a high affinity for Na-metal guarantees intimate contact between solid-Na and a suitable solid-electrolyte separator during charging and discharging, which is crucial to support higher current density and prevent the intrusion of Na-metal dendrites into the solid-electrolyte, which inevitably causes battery failure: i.e., a suitable interlayer increases the critical current density of the cell, helping to ameliorate battery failures. And, since melting Na-metal before applying to a solid-electrolyte is a convenient method to uniformly dispense and apply a Na-metal anode (e.g., charged state or partially charged state cell assembly), utilizing an interfacial layer that exhibits excellent Na-wettability ensures good contact once the Na-metal is cooled.

Disclosed herein are methods for drastically improving alkali metal (e.g., sodium (Na)) wettability on a substrate. In one embodiment, the surface of solid-state electrolytes, such as β″-alumina solid-state electrolyte (BASE) are treated, to augment the performance of Na batteries at lower temperatures.

In one example, the surface treatment is in the form of a slurry or suspension of carbon-black, dispersed in a solvent, which may include an organic solvent, water, or a mixture of these. Additionally, co-solvents may be appropriate to optimize various properties of the suspension, such as dispersion of carbon-black, rheological properties, evaporation rate, wetting on the substrate of choice, etc. Further, a surfactant or detergent may also be added, with the goal of maintaining dispersion of the carbon black and wetting on the substrate of choice. Finally, a binder may be added, which is intended to modify rheology, facilitate stiction of the wetting layer to the substrate after application, and provide mechanical adhesion and strength to the carbon-black layer. Examples of binders include various soluble polymers such as hydroxypropyl methylcellulose, or inorganic salts such as sodium hexametaphosphate, or combinations of such materials. This slurry is then dried on the substrate of choice by various methods such as drop-casting, spray-coating, dip coating, painting, or others, followed by a heat treatment in various atmospheres such as ambient air or nitrogen. For some desired applications of interest, drop-casting has been the method of choice, while spray-coating has yielded more morphologically uniform films than other methods. Heat treatment temperatures may be as high as 550° C. but can be variously modified depending upon the desired outcome. Once the heat treatment process is concluded, Na-wettability indicated by rapid infiltration of the carbon-black based wetting layer by molten sodium when sodium is heated above the melting point in contact with the wetting layer is observed.

This observation is also seen with various other substrates, including those known to exhibit very poor Na-wetting at the temperatures tested. Indeed, while many other substrates such as BASE only show appreciable Na-wetting above ˜300° C., substrates treated with this Na-wetting layer show rapid and excellent wetting at temperatures as low as 110° C., with Na-wetting and spread in the wetting layer occurring as soon as a Na-ingot placed atop the wetting layer melts.

The wetting treatment disclosed herein has several advantages, one important one being that it does not require any metals (e.g., Pb, Sn, or others), which are generally required in similar treatments. For this reason, the term ‘Metal-Free Wetting Layer’ (MFWL) may be used to describe one of the physical embodiments of the treatment. Successful application of a MFWL with excellent Na-wetting can be obtained using slurries comprising an alcohol only or a solvent primarily of water with co-solvents and additives. In certain embodiments, these additives include a small amount of an alcohol and both a surfactant and a binder.

The presently disclosed heat treatments in both air or nitrogen show successful Na-wetting, generally when the heat treatment temperature is between 250-450° C. in air or 350-550° C. in nitrogen. Other compositions or mechanisms to apply the coating as well as other post-application treatments that confer good Na-wetting are also contemplated. Most prior works using carbon-black or carbon pastes, such performance was not conferred at low temperatures. While not bound by any theory, it is believed that the morphology (porosity, etc.) of the resultant film, the surface chemical functionality, or a combination of these is responsible for good Na-wetting, and the combination of components in the slurries may be optimized to impart the correct morphology and/or surface functionality. Finally, it has been observed that the atmosphere within which wetting experiments are performed or symmetric cells are assembled can have an effect on wetting-for example, purging a glovebox with fresh N₂ before experiments seems to be helpful to ensure that no volatile species, O₂, or H₂O are present.

The present disclosed wetting treatment compositions coat the anode side of a solid-electrolyte using inexpensive components, a simple application method, and versatile heat treatment conditions, including simple heat treatment in air. As will be discussed in greater detail subsequently, this work was conceived of as an improvement on much prior work all of which have various drawbacks including complexity, toxicity of components, limited ease of application, and cost of components.

In contrast to prior art, the wetting treatment compositions disclosed herein require no costly or toxic metals, does not require synthesis of unique carbon compounds, and can be applied from a very simple ‘ink,’ which is also based on non-toxic and inexpensive solvents and additives, consisting primarily of water. Despite its simplicity, this Na-MFWL confers Na-wettability that is comparable or superior to previous methods. Full investigation into this technique is ongoing, but symmetric cells, tested to assess the ability of a Na-wetting treatment to minimize cell resistance, have so far shown good performance, which is comparable to previous results using other wetting compounds. Major differences from other methods include the lack of requirement for a metal source, better dispersion of the slurry by use of surfactants, the ability to drop-cast a substantially self-leveling film rather than manually painting the substrate, and the ability to heat treat the MFWL in air rather than under N₂ or another cover gas, which can be performed but is not required.

The wetting treatment compositions disclosed herein may be used with to improve the wetting performance of alkali metals and alkali metal-containing materials on substrates. In certain embodiments, the alkali metal is sodium. In certain embodiments, the alkali metal is potassium. In certain embodiments, the alkali metal is lithium.

Illustrative carbon-containing materials include carbon black, hard carbon, graphite, graphene, carbon fiber, and carbon felt. In certain embodiments, the carbon-containing material is carbon black. In certain embodiments, the wetting treatment composition includes a mixture of carbon black and hard carbon. For example, the wetting treatment composition may include 80 wt % to 95 wt % carbon black, and 5 wt % to 20 wt % hard carbon, based on the total amount of all the carbon-containing material. In certain embodiments, the carbon-containing material is in the form of a powder with primary particle sizes in the range of 20-50 nm and specific surface areas in the range of 200-300 m² g⁻¹. In other embodiments the specific surface area may be higher (800-1200 m² g⁻¹), with smaller primary particle sizes.

The amount of carbon-containing material in the wetting treatment composition may range from 1.5 wt % to 4.5 wt %, or 0.5 wt % to 1.5 wt %, or 5 to 10 wt %, based on the total weight of the wetting treatment composition.

In certain embodiments, the wetting treatment composition may include porous carbon black alone (i.e., without any additives).

In certain embodiments, the carbon-containing material is electrically conductive carbon black. Examples of suitable electrically conductive carbon black include carbon blacks with primary particle sizes in the range of 20-50 nm and specific surface areas in the range of 200-300 m² g⁻¹. In other embodiments the specific surface area may be higher (800-1200 m² g⁻¹), with smaller primary particle sizes. Illustrative suitable electrically conductive carbon black include Vulcan® carbon black commercially available from Cabot, Ketjenblack™ carbon black commercially available from Nouryon, and Super P® carbon black commercially available from Imerys.

In certain examples, higher surface area (e.g., >250 m² g⁻¹) carbon black imparts improved properties to the surface wetting performance to the compositions disclosed herein. In particular, air annealing with high surface area carbon black between 350-400° C. for relatively short periods of time achieves better performance than N₂ annealing at 550° C., as well as better performance than lower surface area carbon black processed at 250-400° C. in air.

The solvent for the wetting treatment compositions may be water only, an alcohol (e.g., methanol) or mixture of alcohols only, a mixture of an alcohol and water, or water and at least one co-solvent (e.g., glycerol). Other suitable organic solvent systems include alkanes (e.g., hexanes) or the like.

One embodiment of an aqueous solvent system for the wetting treatment composition is a mixture of an alcohol and water. Illustrative alcohols include ethanol, methanol, or isopropanol, among others. The ratio of alcohol to water can be 5 vol % to 95 vol % alcohol and 95 vol % to 5 vol % water. One example is 10 vol % ethanol and 90 vol % water.

In certain embodiments, the surfactant is a non-ionic surfactant. Illustrative non-ionic surfactants include a secondary ethoxylated alcohol, an oleate, a polysorbate, or a mixture thereof. In certain embodiments, the surfactant may be included in the wetting treatment composition in an amount of 0.01 wt % to 1 wt %, more particularly 0.05 wt % to 0.15 wt %, based on the total weight of the wetting treatment composition.

In certain embodiments, the binder is an organic binder. Illustrative binders include poly(vinylpyrrolidone), hydroxypropyl methylcellulose, polyacrylic acid, or a mixture thereof. In certain embodiments, the binder may be included in the wetting treatment composition in an amount of 0.01 wt % to 1 wt %, more particularly 0.01 to 0.1 wt % based on the total weight of the wetting composition.

Another possible additive for the wetting treatment composition is urea or other suitable nitrogen-bearing compounds.

In one aspect, the wetting treatment composition may include at least one salt, particularly a sodium, lithium or potassium salt. Illustrative sodium salts include Na₆(PO₃)₆ (sodium hexametaphosphate (SHMP)), NaCl, Na₂SO₄, or a mixture thereof. Other forms of a given class of salt e.g., phosphate, pyrophosphate, metaphosphate, orthophosphate etc. could also be used for example. In certain embodiments, the sodium salt is Na₆(PO₃)₆. In certain embodiments, the sodium salt may be included in the wetting treatment composition in an amount of 1:1 to 1:10, more particularly 1:3, sodium salt: carbon-containing material.

In one aspect particularly suitable for solid sodium anodes, the wetting treatment composition may include at least one metal precursor. Examples of metals for the metal precursor include Sn, Sb, or other metals that suitably alloy with sodium metal. The metal precursor may be a metalorganic precursor such as an ethylhexanoate, oxalate or acetate. Illustrative metal precursors include tin (II) ethylhexanoate, tin (II) oxalate, and antimony (III) acetate. In certain embodiments, the metal precursor may be included in the wetting treatment composition in an amount of 0.1 wt % to 5 wt %, relative to the weight of the carbon-containing material included in the wetting treatment composition.

The wetting treatment composition may be a slurry that has a total solids content of 0.1% to 10%, or 4% to 25%, based on the total mass of the slurry.

The ingredients of the wetting treatment composition may be mixed together, and optionally ground, by any means. Illustrative mixing/grinding methods include milling (e.g., in a planetary mill) or stirring in a suitable vessel.

Application of the wetting treatment composition to a substrate surface can be accomplished by drop-casting, dip-coating, spin coating, or spray-coating. The composition may be applied to the substrate surface under ambient atmospheric conditions or optionally with heating of the substrate at suitable temperatures (e.g., 60° C.) or under non-ambient atmospheres (e.g., low pressure, inert atmosphere).

After the composition is applied to the surface, the composition-applied surface is thermally treated (i.e., annealed). Annealing can be performed in an inert atmosphere (e.g., N₂,

Ar or a mixture thereof), ambient air atmosphere, or a reducing atmosphere (e.g., a percentage (e.g., 5%) of H₂ in N₂.

In certain embodiments with an inert atmosphere the heating atmosphere temperature is 450° C. to 750° C., more particularly 450° C. to 550° C., and most particularly 500° C. to 550° C. The heat treatment time may be 0.5 hours to 12 hours, more particularly 1 hour to 5 hours.

In certain embodiments with an ambient atmosphere the heating atmosphere temperature is 300° C. to 450° C., more particularly 350° C. to 400° C. The heat treatment time may be 5 minutes to 5 hours, more particularly 30 minutes to 1 hour.

The resultant film after heat treatment has a suitable pore structure to take advantage of the intrinsic sodiophilic character of the carbon-containing material for example with a broad pore size distribution with pore diameters ranging from a 2 or 3 nm to 2 or 3 μm, and surface area in the range of 100-200 m² g⁻¹.

The surface-treated solid electrolyte disclosed herein is suitable as a component of sodium energy storage devices including, but not limited to, ZEBRA batteries, sodium metal halide batteries, liquid sodium batteries, molten sodium batteries, sodium-sulfur (Na/S) batteries, and intermediate temperature (<200° C.) sodium beta batteries. The surface-treated solid electrolyte disclosed herein is particularly useful in sodium metal halide batteries operated at temperatures of less than, or equal to, 200° C., or less than 150° C., or from 110 to 150° C. Sodium energy storage devices may be employed as components in energy producing devices and systems such as, e.g., power-grid systems and in other energy producing applications.

### Examples

### Na Wettability

A primarily aqueous solvent system was chosen, with a small amount (10% by volume) of ethanol as a co-solvent. Due to the hydrophobic nature of carbon black, a stable suspension could not be prepared despite the ethanol co-solvent, so a non-ionic dispersant was employed, in this case Tergitol 15-S-9 (Tergitol), which is a biodegradable alternative to the commonly used Triton X-100 detergent. Finally, a sustainable and easily sourced polymer binder was chosen, namely hydroxypropyl methylcellulose (HPMC), to improve stiction and cohesion of the MFWL films on substrates after deposition. This simple ink consisting of carbon black, water, co-solvent, binder, and dispersant can be easily prepared simply by stirring overnight on a stir plate and does not require high energy mixing such as a ball-mill or planetary centrifugal mixer to result in stable, uniform suspensions. This factor bodes well for its applicability at larger scales for molten-Na batteries.

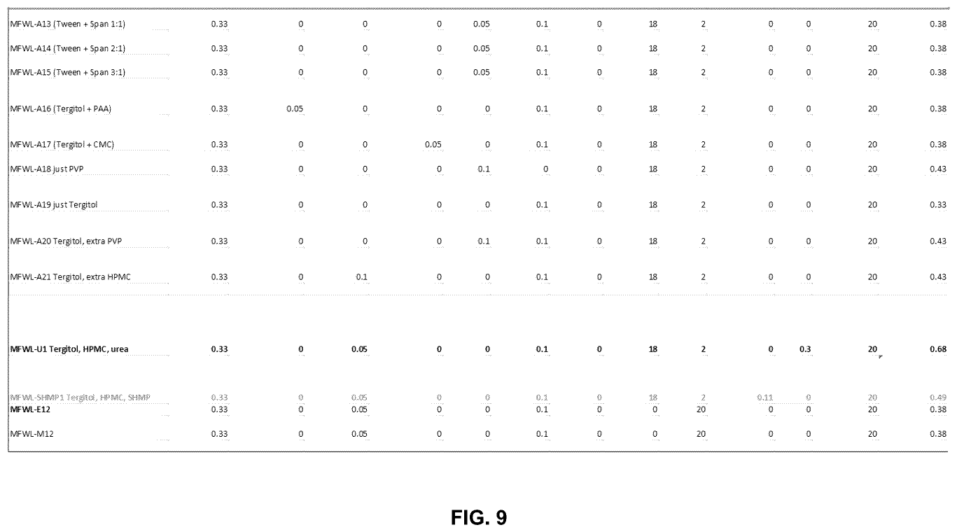

Illustrative wetting treatment compositions are shown in FIG. 9. The A12 composition was used as a baseline composition for subsequent experiments and various additives. The A12 composition with sodium hexametaphosphate (SHMP) demonstrated improved properties. The A12 composition with added NaNO₃ changed from sodiophilic to sodiophobic. In contrast the A12 composition with added Na₆(PO₃)₆ retained excellent wettability.

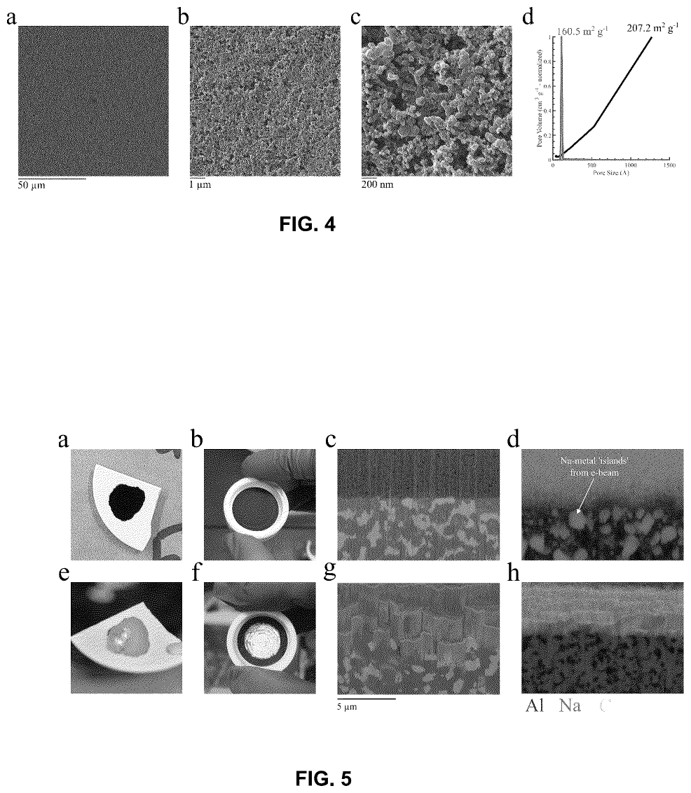

With an easily preparable aqueous wetting agent identified, MFWL-treated BASE substrates were prepared simply by drop-casting of the MFWL ink, drying, and a heat treatment under flowing N₂ at 550° C. The morphology of this MFWL was examined by Helium-Ion Microscopy (HIM) imaging (FIG. 4a), and reveals a highly uniform, smooth surface at low magnifications. At higher magnification, an interconnected network of carbon black particles with submicron to nanosized pores can be seen (FIG. 4b, c). The metal-free carbon-paste, in contrast, was observed to have large agglomerates of carbon black, with a non-uniform surface structure, which was confirmed with better resolution and surface sensitivity by HIM imaging. Beyond this morphological characterization, the internal surface area, pore volume, and pore size distribution was assessed via N₂ adsorption isotherms using Brunauer-Emmett-Teller/Barrett-Joyner-Halenda (BET/BJH) analyses. For comparison, the carbon-paste (so-called ‘CP-0’) was also assessed using these techniques. Despite use of the same carbon black precursor and the addition of polymer binder to the MFWL presented in this work, the measured surface area was ˜29% larger than that of the former carbon-paste formulation (207.2 m² g⁻¹ for MFWL vs. 160.5 m² g⁻¹ for carbon-paste). Further, where the carbon-paste CP-0 possesses a single peak in the pore size distribution in the micro/meso/macro-pore range (i.e., <1 nm, 2-50 nm, 50-300 nm respectively) at around 10 nm, the MFWL film shows a sloping increase on pore size without a single peak. Taken in conjunction with the higher resolution HIM images of the MFWL, this result from the BJH measurement indicates that there is a wide-ranging distribution of pore sizes arranged hierarchically, allowing a gradation in the pore size from the macro-scale down to the range of a few nm. For this reason, we attribute the drastically improved wettability of molten Na in our current MFWL to the uniform surface and range of porosity of the well-dispersed carbon black afforded by the improvements to suspension quality of the MFWL ink demonstrated herein. We hypothesize that the wider range of pore sizes facilitates Na intrusion by allowing surface tension to be broken initially by larger pores, followed by intrusion of molten Na into smaller pores due to the apparent intrinsic affinity of Na-metal for carbon surfaces. In short, since the chemical state of the carbon black should be essentially identical (exposure to aqueous solution, drying, heat treatment on the same substrate) between the two different methods, the microstructure is the best explanation for the differences in wetting behavior.

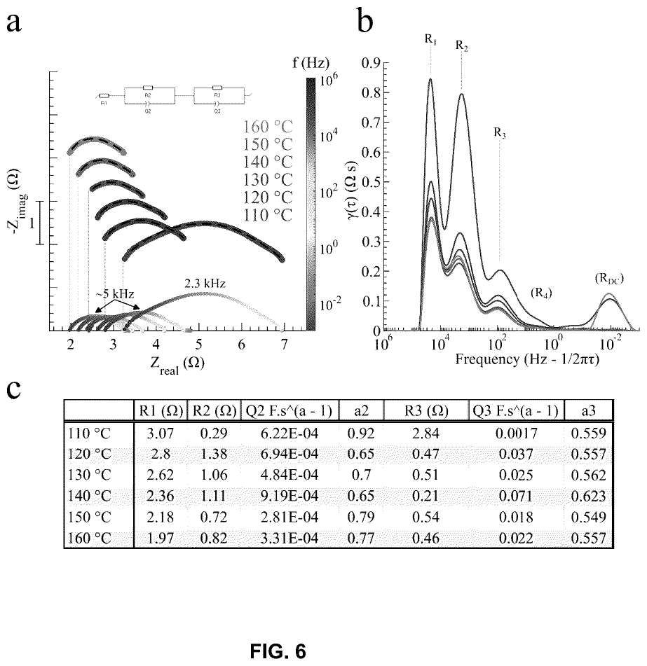

FIG. 5a shows a photo of an example BASE piece with a MFWL deposited on one side, which was used for PFIB cross-sectioning and analysis. FIG. 5b shows a photo of this MFWL in an actual button cell, such as those used for subsequent electrochemical testing and characterization. While infiltration of molten Na into the carbon matrix of these MFWL's is a crucial first step, the most important interface is that between the infiltrated Na-metal and the underlying solid-electrolyte (BASE in this case). To assess this, plasma-focused-ion-beam (PFIB) cross-sectioning was performed on both unsodiated and sodiated MFWL samples on BASE substrates. FIG. 5c shows the cross-section of an unsodiated MFWL on BASE after ion-milling and polishing, revealing a uniform pore structure and size distribution from top to bottom of the MFWL as well as intimate contact between this MFWL and the underlying BASE substrate. SEM-EDS mapping (FIG. 5d) further confirms that an intimate interface is formed between the carbon and BASE.

Note that in FIG. 5d the ‘islands’ of Na-signal intensity present in the EDS map but not in the SEM image are believed to be pure Na-metal expelled from the BASE electrolyte during EDS-mapping due to reduction by the electron beam. This phenomenon was observed in garnet-type Li solid-electrolytes under high electron beam current by Xie et al.,³⁷ and explains the evolution of the MFWL-BASE cross-section during EDS mapping. We believe this is most likely due to insufficient grounding of the sample during EDS mapping and charge buildup at high e-beam currents. For comparison, an SEM image of this same interface shows some regions with Na-metal expulsion and another region (which was not EDS-mapped) without these Na-metal ‘islands’ present.

Application of Na-metal results in rapid distribution of molten Na through the MFWL on BASE (FIG. 5e). Likewise, FIG. 5f shows the Na-metal on the anode side of a cycled and disassembled button cell used for testing the electrochemical characteristics of these MFWL's. Note that the limited area of Na-metal on the anode corresponds to the active area of the cathode side (3 cm⁻²). For comparison with FIG. 5c, FIG. 5g shows an ion-milled and polished cross-section of a sodiated MFWL on BASE after cryo-milling. Cryo-milling is used in this case to prevent volatilization of Na-metal under a high flux ion beam, and to help create a sharper interface due to the significant difference in properties between Na-metal and BASE. However, the difference in milling rate between cryogenic Na-metal and the hard BASE ceramic apparently produces a columnar structure to the polished face under the milling conditions used in this study. Optimization of ion-milling parameters for these samples is challenging and ongoing, but regardless the result clearly confirms that the MFWL enables an extremely intimate interface between Na-metal and the underlying BASE, as confirmed in the EDS map shown in FIG. 5h. Note that the signals from carbon (green) and sodium (red) overlap perfectly in FIG. 5h, indicating that Na is uniformly dispersed throughout the mesoporous carbon matrix. Note that some of the underlying Al x-ray signal can be observed underneath the reddish-orange composite Na and C signals in FIG. 5h at the interface—this is due to the relatively high electron transparency of the thin layer of Na-metal/MFWL present on the columnar structure. At each ‘step’ of this columnar structure, a clean and intimate interface between Na-MFWL and BASE can be still observed. Finally, plan-view SEM images of unsodiated and sodiated MFWL on BASE reveal that Na-metal completely fills the porous MFWL, and a comparable surface roughness to the unsodiated film is preserved. One nuanced but crucial conclusion that can be drawn from this morphological characterization is that the Na-metal infiltrates rather than displaces the carbon matrix, which implies that the film will preserve the intimate contact and sodiophilic character of the MFWL over extended cycling. This effect was not observed in the interaction between molten Na and bare carbon black, rather the carbon black was pulled into the Na-metal droplet. We believe the addition of a polymer binder, which converts to pure carbon upon heat treatment, bridges the individual carbon black particles, and helps maintain a robust pore structure during Na-transport on charge and discharge.

In order to assess the ability of this MFWL to enable low interfacial resistance and facilitate high Na-flux during cycling, symmetric Na—Na button cells were assembled. Briefly, BASE is glass-sealed to an alumina fixture (such as shown in FIG. 5b) followed by application of the MFWL to the bottom (anode) side. Rather than apply MFWL to the cathode side as well, the ‘standard’ lead-acetate-trihydrate (LAT) surface treatment was applied to the cathode side This choice of surface treatment on the cathode was motived by the fact that a steel mesh treated with LAT is used to evenly distribute the molten Na in the cathode compartment, which itself could introduce Pb into the cathode-side surface treatment. Instead of attempting to account for the relative contributions of Pb/MFWL to Na-wetting, the anode side MFWL treatment was paired with a surface treatment known to be effective. In this way, any limitation on the wettability or poor cell performance can be attributed to the MFWL half of the interface.

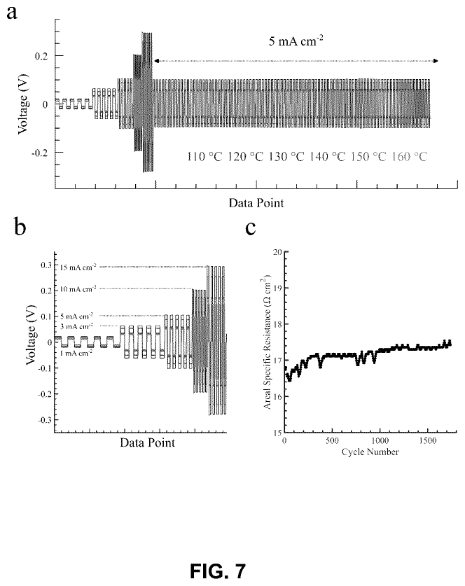

Electrochemical Impedance Spectroscopy (EIS) was used to understand the overall resistance of one such symmetric cell as a function of temperature between 110-160° C., with Nyquist plots of impedance shown in FIG. 6a. Note that each datapoint is colored by frequency such that the frequency range can be readily discerned from the Nyquist plot. As expected, with increasing temperature, the overall impedance decreases, with the reduction in impedance apparently dominated by the lower frequency processes, and only a small reduction in the contribution of the highly ionically conductive BASE electrolyte. In order to more accurately determine a suitable equivalent circuit model, the Distribution of Relaxation Times (DRT) technique, which has been used to inform EIS circuit fitting, was applied. Specifically the DRTools Matlab software package from Wan et al. was used for DRT analysis. Plots of DRT for each impedance spectrum in FIG. 6a are shown in FIG. 6b. In general, three primary peaks are readily observed, with a fourth small peak arising for the lowest temperature impedance spectrum. In two spectra, a low frequency peak is also observed (the red data points for the 120° C. and 160° C. impedance spectra in FIG. 6a). This low frequency peak is believed to be a most probably a purely resistive near-DC process, which does not seem to be temperature dependent but rather may arise from the connections to the cell for those two measurements, and is thus excluded from circuit fitting. With these conclusions informed from DRT analysis, the impedance spectra were fit using the simple circuit model shown in the FIG. 6a inset. Although an additional parallel resistor/constant-phase elements could potentially improve the fit for the impedance spectrum at 110° C. based on the DRT results (R₄), for ease of comparison and due to the small contribution to impedance of R₄, this was omitted from impedance fitting. Results from circuit fitting are tabulated in FIG. 6c.

The relatively low cell impedance observed in FIG. 6 compares quite favorably with our prior results on Pb-based and carbon/metal-nanoparticle-based sodiophilic surface treatments. This result is especially encouraging given the ease of preparation of the MFWL ‘ink,’ and the lack of any toxic metals. In order to test the cyclability of cells utilizing this MFWL, the same cell as was characterized via EIS in FIG. 6 was subjected to Na—Na symmetric cycling at various temperatures and current densities.

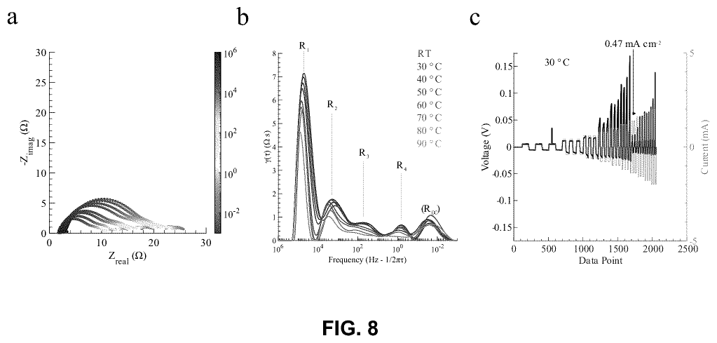

FIG. 7a shows the voltage response of this cell at various temperatures (blue to red—110 to 160° C.) and various current densities. As expected, the overpotential decreases with temperature in accordance with the impedance data shown in FIG. 6. However, the response at each temperature is quite stable, with little deviation from a ‘square wave’ voltage response except at high current density and lower temperature. This conclusion is more obvious when the ‘current-staircase’ portion of the cycling experiment is focused on in FIG. 7b. The overpotential barely increases as the temperature is dropped from 160 to 130° C., increasing slightly more as the temperature is further decreased from 130 to 110° C.

Finally, the long-term cycling stability of the cell at 120° C. and 5 mA cm⁻² was assessed. FIG. 7c shows the specific resistance calculated from the long-term voltage profile using the median voltage from each discharge cycle and the current (15 mA). Clearly, the cell is quite stable over many cycles, with only minor increase in the specific resistance from ˜16.5 Ω cm² to 17.5 Ω cm². This long-term stability further confirms the ability of the MFWL to reliably uptake and release molten Na during charge and discharge, without obvious degradation. A LAT-only Na—Na symmetric cell cycled under the same conditions serves as an excellent baseline comparison for the MFWL results. Crucially, the cell impedance, cyclability, and specific resistance of this cell with MFWL anode treatment and LAT cathode treatment compares extremely well with our previously demonstrated LAT surface treatment, with the obvious benefit of requiring no toxic Pb.

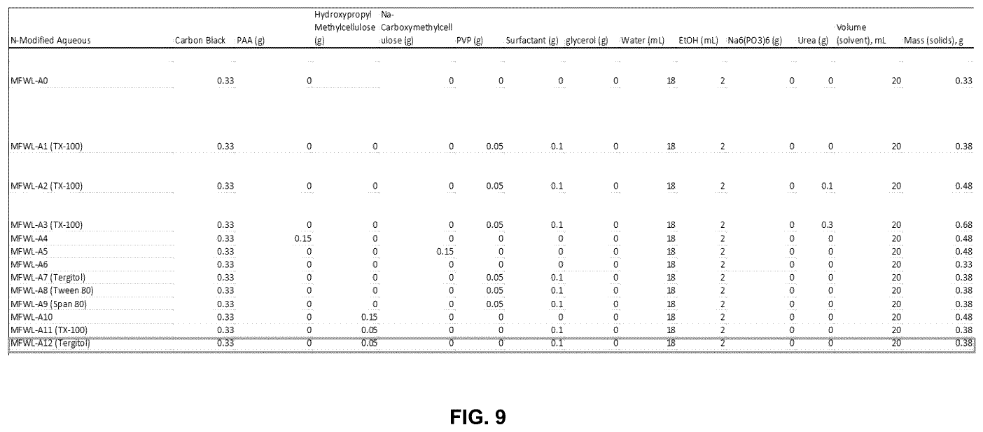

Beyond the obvious utility of using mesoporous MFWL's for sodiophilic surface treatment, this material also has potential utility for solid-state Na-batteries. A similar cell was assembled and cycled at various temperatures and assessed using EIS between 110 and 140° C. Then, the same cell was subjected to solid-state Na cycling at room temperature and from 30-90° C. in 10° C. increments (FIG. 8). At each temperature, an impedance spectrum was acquired (FIG. 8a), which was analyzed using DRT (FIG. 8b) as before. Then, the cell was subjected to a current-staircase between 0.033 and 0.66 mA cm⁻² to determine the critical current density (CCD) at which Na-dendrites penetrate the BASE separator. Clearly, the cell is able to cycle at 30° C. up to a current density of 0.47 mA cm⁻² before an obvious deviation from Ohmic response is observed and the voltage drops as indicated in FIG. 8c. This value of CCD is lower than the record setting values demonstrated by Bay et al., but otherwise compares well with other examples in the literature for NaSICON indicating that our MFWL is an effective method at distributing Na-metal evenly, forming an intimate interface, and spreading current density across the solid-electrolyte-Na-metal interface to minimize current focusing and enable a high CCD.

These promising results indicate that a simple sodiophilic surface treatment consisting solely of carbon can impart comparable or even superior sodium wettability relative to other methods. Most importantly, this wettability is maintained even at low temperatures e.g., just above the melting point of Na, while many similar approaches using carbon only confer reasonable sodium wetting at much higher temperatures. For example, Hu et al. prepared a porous carbon film on BASE by using a sacrificial porogen (PMMA) and a carbon source (glucose) to prepare thin carbon films with pore sizes on the order of 5 μm. To accomplish this, the glucose and PMMA were cross-linked in N,N-dimethylformamide (DMF) in an autoclave before application to the BASE substrate. Following this, the substrate was heat treated at 550° C. in N₂ to form the porous carbon wetting layer. These films resulted in an improvement over Na-wetting on bare BASE, with optimal morphology granting a Na-wetting angle of ˜94.5° at 300° C. This is one of the earlier works that demonstrated the efficacy of a carbon-based sodiophilic treatment on BASE, although the process was apparently somewhat complicated, required an autoclave reaction in toxic DMF to prepare the porous carbon precursor. In another instance, Kim et al. used a carbon-based surface coating on planar Na—NiCl₂ batteries to improve sodium wetting. Despite improvements in performance, especially in utilization of the cathode, the carbon coating only minimally reduced the cell resistance and wetting angle of molten Na, most likely due to the already high operating temperature of 350° C. and reasonable Na-wetting on BASE at this temperature.

At a temperature of 300° C. on the other hand, Wu et al. showed that disordered carbon tubes can confer much better sodium wettability on BASE, as evidenced by a much lower wetting angle of 30°. In this case, rather than molten Na batteries, a quasi-solid-state Na-battery with a solid Na-metal anode was demonstrated, showing a 5× reduction in areal resistance with the carbon coated anode. However, the preparation and initial Na-application are relevant to elevated temperature Na-wetting due to the high temperature used to initially sodiate the carbon layer. While also a pure carbon anode, the preparation method involved a very high temperature calcination under Ar-atmosphere (1100° C.) to prepare the tubular carbon material from cotton, followed by preparation of a slurry based on n-methyl pyrrolidone (NMP), coatings, and finally another lower temperature heat treatment (550° C.) on BASE to prepare the functional coating after casting the carbon tubes. This process should be relatively scalable, but the multiple steps and use of toxic NMP as the solvent to prepare the sodiophilic layer are a hindrance to practical application.

Another pure carbon sodium wetting material comprising ‘sparked’ graphene oxide (‘sGO’) was reported by Jin et al. In that case, a film of graphene oxide was prepared and ‘sparked’ by contact with molten Na at 300° C., causing a rapid reduction of graphene oxide to graphene and simultaneous expansion of the interlayer spacing, while also creating many active Na-sites within the material. The submicron gaps within the sGO scaffold apparently facilitated rapid Na-metal intrusion into the material due to capillarity, as indicated by the permeation of the film by molten Na in less than one second. We believe that a similar effect may occur in our MFWL sodiophilic films due to similarly small and uniform porosity. Furthermore, we also find that Na-metal permeates the MFWL film within a one to two seconds once it melts, although in our case the temperature for wetting testing is only 110° C. rather than 300° C. Although the sodium wetting test performed in Jin et al. was conducted at 300° C., Na—NiCl₂ batteries tested using the sGO anode operated effectively at the significantly lower temperature of 175° C., indicating that the sGO method is highly effective at intermediate temperatures as well. The combination of intrinsic sodiophilic character and capillarity were similarly utilized by Lai et al. in preparing Na-dendrite-resistant reduced graphene oxide (rGO) anodes for room temperature Na-metal batteries.

Landmann et al. utilized a carbon black/sodium hexametaphosphate based wetting treatment, applied via spray-coating, to test out the ability of Na to plate and strip at high current densities. While this coating was quite successful at 250° C., allowing extremely high current densities (up to 2.6 A cm⁻²) in some cases, the performance and wettability of this surface treatment at lower temperature (140° C.) degraded significantly relative to that at 250° C. Finally, two examples of sodiophilic treatments utilizing a small amount of metal that alloys with Na are worth comparing. Naturally, our prior work on Pb- or Sn-containing carbon paste is a fairly direct comparison-beneficially the MFWL method demonstrates even lower specific resistance than these carbon pastes.

Finally, results are certainly promising, showing low resistance even at room temperature, and indicating that the MFWL can also successfully serve as a host for solid Na-metal, finding relevance for solid-state batteries. Utilizing a cell designed to apply pressure to the Na electrodes would likely allow the MFWL to enable yet higher critical current density (CCD), as the CCD determined from the current staircase experiment of 0.47 mA cm⁻² in this work was obtained with no applied pressure, comparing well with the value obtained by Jolly et al. (1.5 mA cm⁻²) for a cell under a significant 4 MPa applied pressure.

We have demonstrated an improvement to sodiophilic surface treatments for elevated temperature Na-metal batteries, comprising a simple mesoporous carbon-based Metal-Free Wetting Layer (MFWL). This MFWL can be applied from a mostly aqueous ink with non-toxic components, and leverages the ability of a simple surfactant to disperse hydrophobic carbon black particles to result in a highly uniform porous carbon film on various substrates. When heat treated at 550° C. in N₂, MFWL have a uniform gradation in porosity ranging from a few nm to hundreds of nm, and high specific surface area of 206.2 m² g⁻¹. Beneficially, achieving this microstructure requires no complicated templating or exotic carbon sources. When applied to a Na-ion conducting ceramic such as BASE, drastically enhanced Na-wetting is observed, with Na-metal actively infiltrating into the MFWL just above its melting temperature. Symmetric Na—Na cells with this MFWL treatment on the anode side show excellent cycling stability, indicating that this approach will be successful for a variety of intermediate temperature molten-Na batteries, and enable the lower temperature operation that is so highly desirable for this promising battery type. Experiments into the application of solid-state Na—Na symmetric cells using this MFWL were conducted showing low resistance and a reasonable critical current density of ˜0.47 mA cm⁻² with no externally applied pressure. We expect this new MFWL treatment to be widely applicable and beneficial for molten and solid-state Na batteries for a variety of applications.

### K-Metal Wettability

A MFWL composition as disclosed herein (Vulcan™ carbon black, Tergitol 15-s-9 surfactant, hydroxypropyl-methylcellulose, heat treatment under flowing N₂ at 550° C.) was applied to a molybdenum disk substrate. Molten K metal was contacted to the MWFL-coated substrate, and rapidly infiltrated into the porous carbon MFWL. The same behavior of K metal as for Na metal indicates that the MFWL compositions are also suitable for applications wherein molten or solid K metal anodes are desired.

### Solid-Na Symmetric Cell

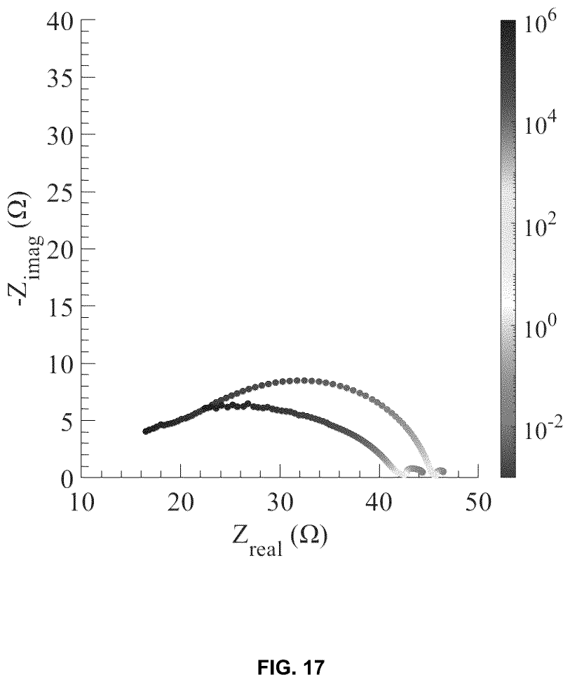

The A12 MFWL composition as disclosed herein was spray coated onto both sides of BASE solid electrolyte disks in a coin cell configuration. Subsequently, molten sodium metal was applied to each side, resulting in rapid and complete wetting of the surface. Then, the symmetric Na—Na cell was assembled into a coin cell case for electrochemical testing. Electrochemical impedance spectra of duplicate solid-state symmetric cells are shown in FIG. 17, revealing low interfacial resistance (lower frequency component between 40-50 Ω on the real axis), which relates to the excellent wetting and uniform contact between Na-metal and the solid-electrolyte.

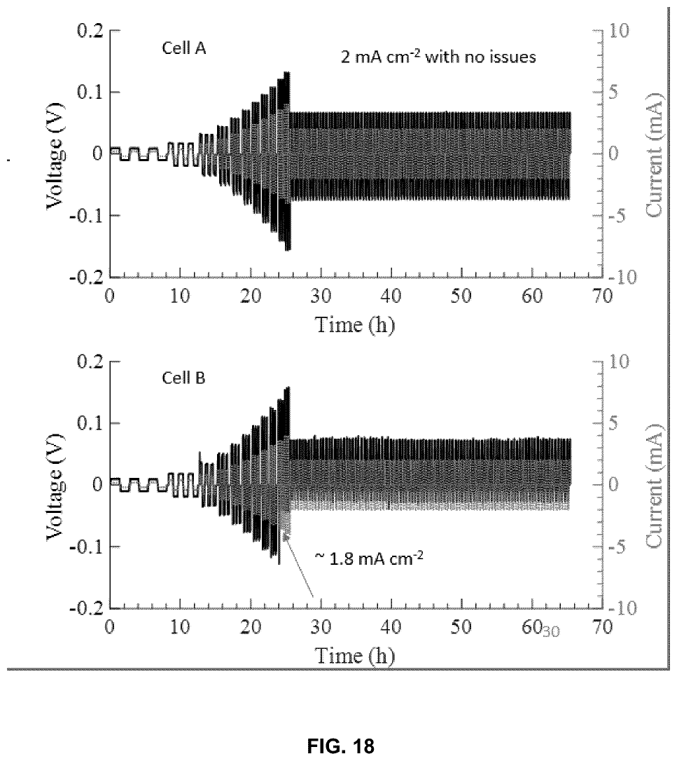

FIG. 18 shows one cell fails due to internal short from a Na-dendrite near 1.8 mA cm⁻² current density, while the other is able to cycle up to 2 mA cm⁻² without internal short.

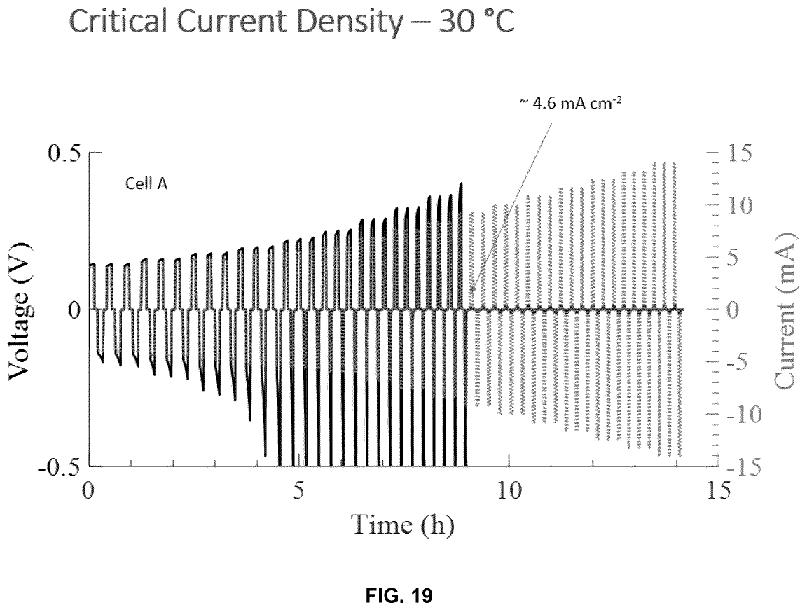

FIG. 19 shows that the cell able to cycle up to 2 mA cm⁻² eventually fails due to internal short at ˜4.6 mA cm⁻².

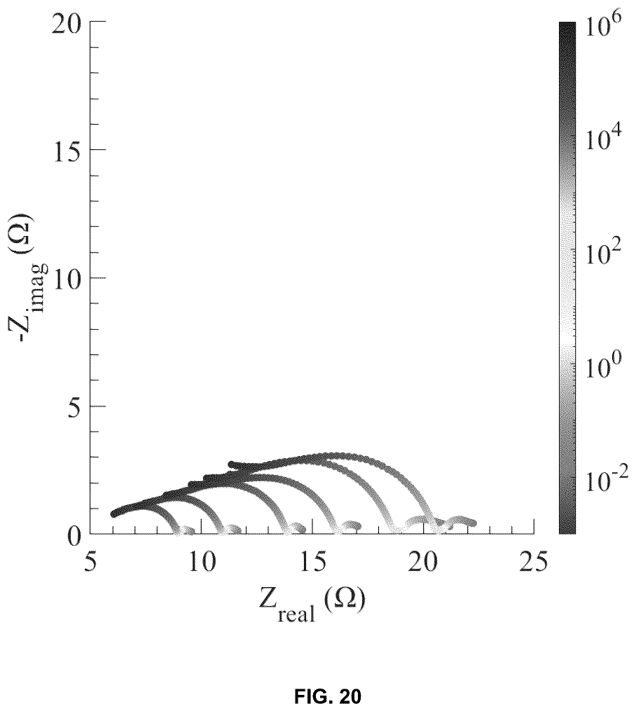

FIG. 20 shows electrochemical impedance spectra of a solid-state Na—Na symmetric cell using a MFWL treatment with SHMP additive, showing that this composition also confers low interfacial resistance at 20, 25, 30, 40, 50, and 60° C. (i.e., overall impedance decreases with increased testing temperature).

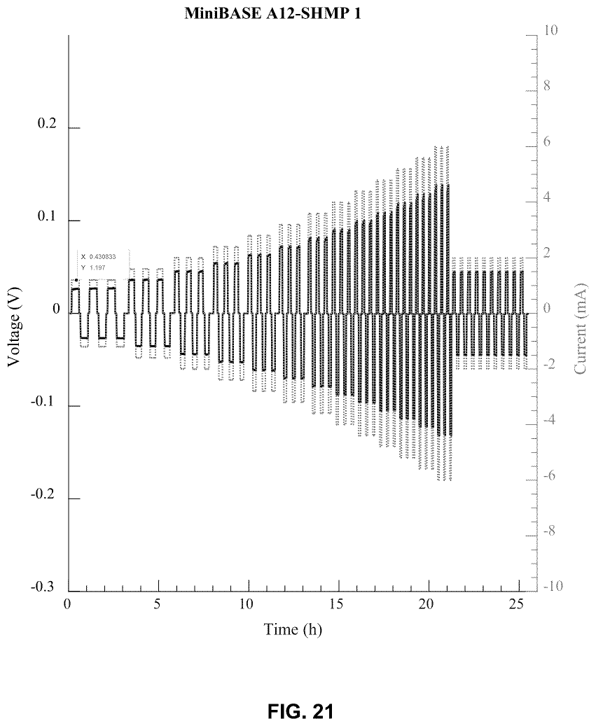

FIG. 21 shows that the aforementioned MFWL-SHMP solid-state Na symmetric cell can cycle up to a current density 3 mA cm⁻² without internal short circuit.

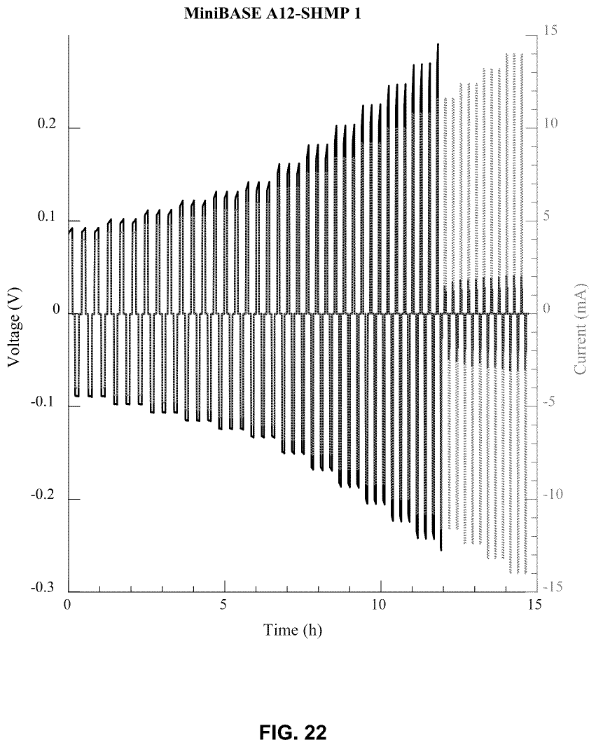

FIG. 22 shows that he aforementioned MFWL-SHMP solid-state Na symmetric cell eventually fails to internal short circuit only at a current density of ˜5.8 mA cm⁻².

In view of the many possible embodiments to which the principles of the disclosed materials, processes and deices may be applied, it should be recognized that the illustrated embodiments are only preferred examples of the invention and should not be taken as limiting the scope of the invention.

What is claimed is:

1. An energy storage system comprising a molten alkali metal in contact with a layer disposed on a surface of a substrate, wherein the surface layer comprises a composite comprising carbon, and the surface layer is metal-free and metal oxide-free.

2. The system of claim 1, wherein the substrate is a β″-alumina solid electrolyte.

3. The system of claim 2, wherein the molten alkali metal comprises sodium.

4. The system of claim 1, wherein the surface layer is porous.

5. The system of claim 1, wherein the carbon comprises carbon black.

6. An energy storage system comprising a solid sodium-containing anode in contact with a surface layer disposed on a solid-state electrolyte, wherein the surface layer comprises a composite comprising carbon, and at least one of tin or antimony.

7. A method comprising applying an aqueous wetting treatment composition to a surface of a substrate, wherein the composition comprises a carbon-containing material, a surfactant, a binder, and a sodium salt, and the composition is metal-free and metal oxide-free; and
thermal treating the composition-applied substate.

8. The method of claim 7, wherein the composition comprises an aqueous solvent that comprises a mixture of an alcohol and water.

9. The method of claim 8, wherein the alcohol is ethanol.

10. The method of claim 7, wherein the surfactant is a secondary ethoxylated alcohol, an oleate, a polysorbate, or a mixture thereof.

11. The method of claim 7, wherein the binder is an organic binder.

12. The method of claim 7, wherein the binder is poly(vinylpyrrolidone), hydroxypropyl methylcellulose, polyacrylic acid, or a mixture thereof.

13. The method of claim 7, wherein the sodium salt is sodium phosphate, sodium orthophosphate, sodium pyrophosphate, sodium metaphosphate, NaCl, Na₂SO₄, or a mixture thereof.

14. The method of claim 7, wherein the sodium salt is Na₆(PO₃)₆.

15. The method of claim 7, wherein the composition further comprises at least one Sn metal precursor, Sb metal precursor, or a mixture thereof.

16. The method of claim 7, wherein the composition further comprises tin (II) ethylhexanoate, tin (II) oxalate, antimony (III) acetate, or a mixture thereof.

17. The method of claim 7, wherein the substate comprises a β″-alumina solid electrolyte.

18. The method of claim 17, wherein the binder is poly(vinylpyrrolidone), hydroxypropyl methylcellulose, polyacrylic acid, or a mixture thereof; and the sodium salt is sodium phosphate, sodium orthophosphate, sodium pyrophosphate, sodium metaphosphate, NaCl, Na₂SO₄, or a mixture thereof.

19. A method for assembling an energy storage system, comprising applying an aqueous composition to a surface of a β″-alumina solid electrolyte, wherein the aqueous composition comprises a carbon-containing material, a surfactant, a binder, and a sodium salt, and the composition is metal oxide-free; thermal treating the composition-applied β″-alumina solid electrolyte resulting in a surface-modified β″-alumina solid electrolyte; and contacting the surface-modified β″-alumina solid electrolyte with a molten alkali metal.

20. The method of claim 19, wherein the molten alkali metal comprises sodium.

21. The method of claim 19, wherein the binder is poly(vinylpyrrolidone), hydroxypropyl methylcellulose, polyacrylic acid, or a mixture thereof; and the sodium salt is sodium phosphate, sodium orthophosphate, sodium pyrophosphate, sodium metaphosphate, NaCl, Na₂SO₄, or a mixture thereof.

22. A method for assembling an energy storage system, comprising applying a composition to a surface of a solid-state electrolyte, wherein the composition comprises porous carbon black, and the composition is metal oxide-free; thermal treating the composition-applied solid-state electrolyte resulting in a surface-modified solid-state electrolyte; and contacting the surface-modified solid-state electrolyte with a molten alkali metal.

23. A method comprising operating a Na-metal halide battery at a temperature of less than, or equal to, 200° C., wherein the Na-metal halide battery comprises a molten sodium-containing anode salt in contact with a surface layer disposed on a β″-alumina solid electrolyte, wherein the surface layer comprises carbon, and the surface layer is metal-free and metal oxide-free.
